(19) United States
(12) Patent Application Publication
(10) Pub. No.: US 2002/0073222 A1
(43) Pub. Date: Jun. 13, 2002

(54) Packet transfer control method

(76) Inventors: Toshi Sonoda, Osaka (JP); Shigeo Konriki, Osaka (JP); Hidehiko Ino, Osaka (JP); Hisaya Ogasawara, Osaka (JP); Hideki Kawada, Osaka (JP); Atsunori Yamamoto, Osaka (JP)

Correspondence Address: KATTEN MUCHIN ZAVIS ROSENMAN, 575 MADISON AVENUE, NEW YORK, NY, 10022-2585, US

(21) Appl. No.: 10/010,418

(22) Filed: Dec. 6, 2001

(30) Foreign Application Priority Data
Dec. 7, 2000 (JP) 2000-373247

(51) Int. Cl. G06F 15/173; G06F 15/16

(52) U.S. Cl. 709/232; 709/238

(57) ABSTRACT

A packet transfer control method and a system employing the method achieve the search of a high capacity and a plurality of parameters required for hardware routing. The method includes the steps of finding, by means of hardware processing, a first route information which has been address solved by a tree search using a destination address contained in the header information of the IP packet; finding a second route information which has been solved by information, excluding the destination address, that specifies a packet; and combining the first and the second route information to judge the execution of transfer to software.

### BACKGROUND OF THE INVENTION

1. Field of the Invention

The present invention relates generally to a packet transfer control, and, more particularly, to a method and a system for controlling a packet transfer in the IP (Internet Protocol) router, etc.

2. Description of the Related Art

When a packet is to be transferred autonomously by hardware, if the packet is difficult to be processed autonomously by hardware, including the routing protocol, protocol for maintenance, etc., such a packet can be analyzed or transferred by software, after once being transferred to a memory, which enables software to refer thereto.

While as for a packet to be autonomously transferred only by hardware, address solution will be performed by a search function (hereinafter referred to as “tree search”) which, based on the destination address contained in the packet header, traces a table while comparing destination addresses per bit starting from the upper, using a tree-structured table. Then, a transfer destination will be determined from the information on the route list that can be looked at based on the search result.

Similarly, most of packets that have to be processed by software will be sent out to its own apparatus address as a destination address. Because of this reason, software processing of packets can be started, after transferring packets to a memory that can be looked at by software, by setting the necessity of software processing for the route list, performing similar address solution from the destination address.

However, in most cases, processing by software is significantly slower than an autonomous transfer by hardware. Because of this reason, processing can be made by this method only for a part of packets to be inputted from the interface.

To such a apparatus, if, from another apparatus connected to the apparatus or from a subscriber accommodated in the apparatus, due to an erroneous setting, etc., large amounts of packets, that the above-mentioned apparatus is not required to process, would be sent by a protocol to the address representing the own apparatus, the amount of the arrived packets could exceed the processing ability of software. Therefore, a problem can take place that a packet that should essentially be processed may be discarded because of the overflowing queue for transfer.

As countermeasures against such a case, in addition to an address solution function, including a tree search, etc., a method can also be considered to perform software processing only when both of a destination address and the number representing the type of a protocol are matched, by hardware for search, such as a CAM (Content Addressable Memory) being mounted.

However, the CAM is a memory that can be searched by hardware, as to one inputted data, whether or not the inputted data is within set data. And, the set data includes concerned data and a mask that determines the effective range for each data.

Therefore, the tree search method can be embodied using a normal RAM, and large capacity of the normal RAM can be obtained with comparatively ease, however, when the CAM is used, the number of data that can be set would be limited. Because of this limitation, the tree search method was not efficient, for such devices that would be required to register large amounts of addresses representing own devices.

Further, on an apparatus to transfer a packet, to embody differentiated services in delayed transfer of a packet, degrees of discard priority, etc., the packet having the specified sending and receiving address or specified protocol type may be searched according to the input interface information, using the CAM (hereinafter, these group of packets extracted with the same condition will be referred to as flow, and the search for that purpose will be referred to as flow search), and a transfer route to a destination, depending on the result, may be selected or a transmission band may be controlled.

In most of such a case as described above, a send function would be controlled, by means of setting, as a pair, the information on the transfer route to a destination and parameters for transmission band control, on a route list to be looked at by the result of the flow search.

However, for instance, if the amount of packets sent from a source address is to be transferred with the total amount being limited, or when a transmission band is to be restricted by the total amount of protocol communication, in order to perform the above operation using the above-mentioned method, search conditions should be set in just like a network or mesh shape for each of all the flows that can be assumed.

Generally, as the number of data that can be set for the CAM would not be so much, the setting of the flow search conditions in the network or mesh shape as described above was not efficient in terms of the size of the apparatus or in terms of cost.

### SUMMARY OF THE INVENTION

It is therefore an object of the present invention to provide a packet transfer control method and a system for the purpose of achieving the search of a high capacity and a plurality of parameters required for hardware routing.

Another object of the present invention is to provide a packet transfer control method and a system to improve the reliability of a apparatus, by allowing software not to process useless packets and preventing software from discarding a packet that essentially needs processing.

A further object of the present invention is to provide a packet transfer control method and system that enable the reduction in loading software, and at the same time, improvement of the total processing performance of software, including abnormal processing.

Yet another object of the present invention is to provide a packet transfer control method and a system to enable an embodiment of a more economic and smaller type of a complex priority control, compared with the conventional method.

As a basic concept, a packet transfer control method to attain the above objects of the present invention will execute both of the tree search and flow search for every packet and use the information combined by hardware and shown on the route list that can be looked at from the individual search results, so as to solve the problems as described above.

After the tree search function is allowed to solve the destination address, and the flow search function is allowed to select the type of a protocol, a packet will be transferred to a memory that can be looked at by software, only when the information shown on the route list referred to by the individual functions matched a certain condition. But, if not matched, by allowing packets to be discarded without being software processed, only the packets subject to software processing can be processed.

Further, the tree search function will be allowed to search the transfer route from the destination address, and the flow search function will be allowed to identify the source address other than the destination address, and the type of a protocol, as well.

Moreover, by the use of parameters listed up in the route list referred to by the flow search as the band control parameters, the band can be controlled independently from the transfer route.

The features of the present invention will become more apparent from preferred embodiments of the present invention which will be described hereinbelow with reference to the accompanying drawings.

### BRIEF DESCRIPTION OF THE DRAWINGS

FIG. 1 shows an example of a configuration of a network applying the present invention;

FIG. 2 shows a configuration of the connection between a functional block of an edge node 41 and an ATMSW 40;

FIG. 3 shows a functional block diagram showing an embodiment of an address solution UNIT 50 under the present invention;

FIG. 4 is a configuration drawing showing an example of configuration of a flow search circuit 53;

FIG. 5 shows an example of route information;

FIG. 6 shows an example of judgment logic at a judgment circuit 56;

FIG. 7 shows functional configurations and flow of movement of a field ID search UNIT 532 to search a specified flow from an IP header, and a flow search UNIT 533;

FIG. 8 shows an example of a table of the field ID search UNIT 532, and a method to obtain a field match ID 0 (3c), and further shows an example of a table of a CAM 531;

FIG. 9 illustrates a method to output field match IDs 1 and 2 (3c);

FIG. 10 illustrates a method to generate search conditions of the flow ID search UNIT 533, and a method to obtain a flow ID 0 (4c); and

FIG. 11 illustrates a method to obtain flow IDs 1 and 2 (4c) of the flow ID search UNIT 533, and a method to output a final flow ID (4d).

### DESCRIPTION OF THE PREFERRED EMBODIMENTS

The following is a description of the embodiments of the present invention, in conjunction with the drawings. It is to be understood that the embodiments shown in the drawings are only for facilitating the understanding of the present invention, and that the application of the present invention is not limited to these embodiments.

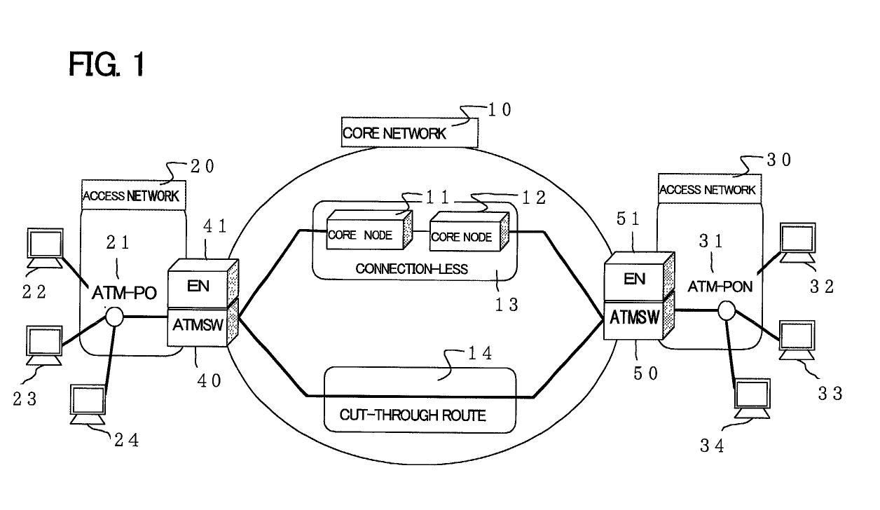

FIG. 1 shows an example of configuring a network applying the present invention.

In FIG. 1, the network comprises a core network 10 having a route to embody an economy service and a high quality service, and access networks 20 and 30 comprising the existing ATM network.

Moreover, the core network 10 and the access networks 20 and 30 are connected to ATMSWs 40 and 50, general-purpose ATM switches, and hardware routing for the IP packet will be executed by edge nodes 41 and 51.

As a function to execute hardware routing, the flow search processing will be executed at the edge node 41.

The core network 10 has two routes, one is a connection-less route 13 for economy service, and the other is a cut-through route 14 for high quality service. The connection-less route 13 will be established by core nodes 11 and 12. The core nodes 11 and 12 will execute high-speed transfer using a core address to be added when a packet passes through the core network 10.

In the access networks 20 and 30, ATM-PONs 21 and 31, which are optical fiber networks for the ATM respectively contain a plurality of terminal devices 22, 23, 24 and as well as 32, 33, and 34 connected to ATM and also have a function to repeat a packet from the terminal devices to the ATMSWs 40 and 50.

As illustrated in FIG. 1, by configuring the network, the IP packet within the ATM cell transferred from the access networks 20 and 30 can be transferred through the core network 10, via an optimum route, by converting every destination of the IP packet into a core address.

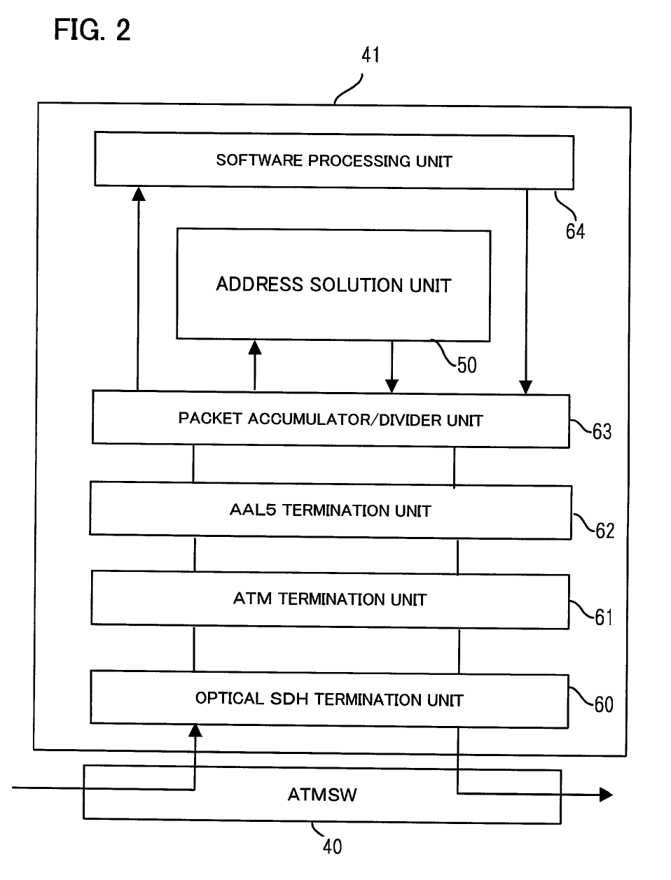

FIG. 2 shows a configuration of connection between a function block for the edge node 41 and the ATMSW 40, as an example of embodiment. And, connection between a function block for the edge node 51 and the ATMSW 50 is in the same configuration.

In FIG. 2, an optical SDH termination UNIT 60 will convert an optical signal inputted via the ATMSW 40 into an electrical signal. An ATM termination UNIT 61 will convert the ATMVPI/VCI into a channel to be used within the apparatus, and will control the rate for sending intervals. An AAL5 termination UNIT 62 has the function of the AAL5, and will control re-sending and detect errors.

Moreover, a packet accumulator/divider UNIT 63 will accumulate the arrived packets, and will disassemble/assemble the IP header for the IP packet and data.

In such a configuration, the edge node 41 will execute a series of motions as described below:

1. The packet within the ATM cell sent from the access network 20 or the core network 10 will be sent to the optical SDH termination UNIT 60, via the ATMSW 40;

2. The optical SDH termination UNIT 60 will convert an optical ATM cell packet signal into an electrical signal, and moreover, it will disassemble the ATM cell packet and convert to individual ATM cells, so as to output to the ATM termination UNIT 61;

3. The ATM termination UNIT 61 will convert the VPI/VCI for the ATM cell to a channel to be used in the interior (hereinafter referred to as internal channel), and output to the AAL5 termination UNIT 62;

4. The AAL5 termination UNIT 62 will detect errors or other processing of the AAL5, for the ATM cell;

5. The packet accumulator/divider UNIT 63 will hold the arrived packet and cut out a header consisting of an IP header, a core header and control information;

6. An address solution UNIT 50 will receive the header, and will perform hardware routing, extracting the necessary parameters from the header. As a result of this processing, either hardware transfer or software transfer will be determined, and output to the packet accumulator/divider UNIT 63 will be executed;

7-1. In the case of hardware transfer

When hardware transfer is determined at the address solution UNIT 50, the packet accumulator/divider UNIT 63 will assemble its holding data and the inputted header, and output to the AAL5 termination UNIT 62;

7-2. In the case of software transfer

When software transfer is determined at the address solution UNIT 50, the packet accumulator/divider UNIT 63 will assemble its holding data and the inputted header and execute software transfer through a software processing UNIT 64; and 8. As the AAL5 termination UNIT 62, the ATM termination UNIT 61 and the SDH termination UNIT 60 have the reverse functions of those described above, by outputting a packet in the reverse order of transferring the packet, the packet will be transferred to the core network 10 or the access network 20 through the ATMSW 40.

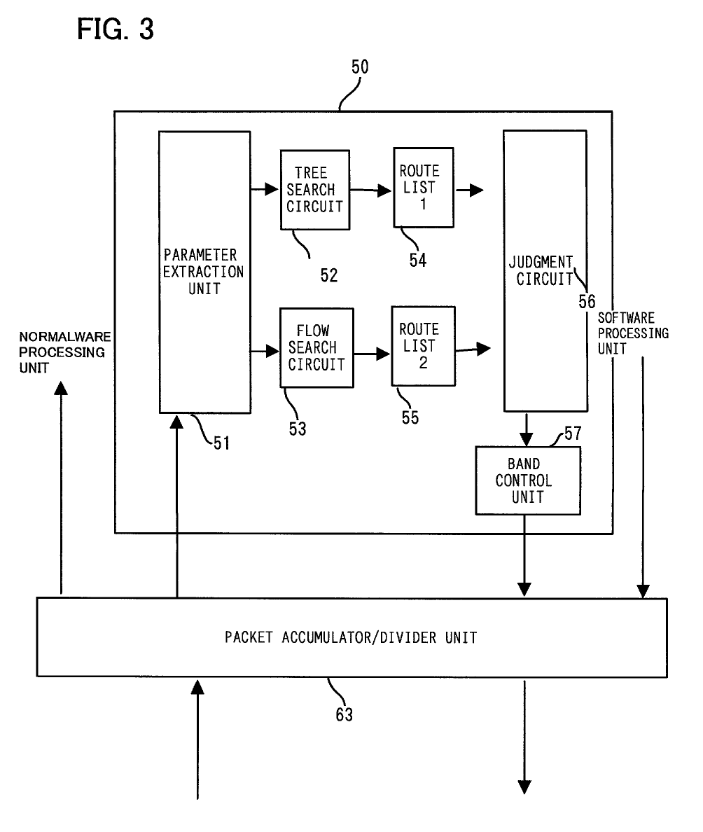

FIG. 3 shows a functional block diagram representing an embodiment of the address solution UNIT 50 according to the present invention.

The address solution UNIT 50 is configured, by including a parameter extraction UNIT 51, a tree search circuit 52, a flow search circuit 53, a first route list 54, a second route list 55, a judgment circuit 56 and a band control UNIT 57.

The parameter extraction UNIT 51 will extract necessary information from the information of the IP (Internet Protocol) header within the header, core header information, and control information. The following shows some specific parameters used in these information for the present invention.

The IP/core header information uses a destination address, sending source address, type of protocol, TCP (Transmission Control Protocol) /UDP(User Datagram Protocol) port No., etc.

The control information uses the internal channel converted from the VPI (Virtual Path Identifier)/VCI (Virtual Channel Identifier) and CLP denoting a cell loss priority. These parameters are used in the tree search circuit 52 and the flow search circuit 53.

The tree search circuit 52, one of the search methods, will search a destination using a half-tree structured table, with a destination address of the extracted parameter as a search condition. The result of search will be a pointer to a route information contained in the first route list 54.

The flow search circuit 53, one of the other search methods, will search a flow that fulfils a specified condition, using the CAM (content Addressable Memory), with an arbitrary combination of all of the extracted parameters as a search condition. The CAM is a memory that is able to search whether or not the input data is within the pre-set data. The search result of the flow search circuit 53 will be a pointer to a route information in the second route list 55.

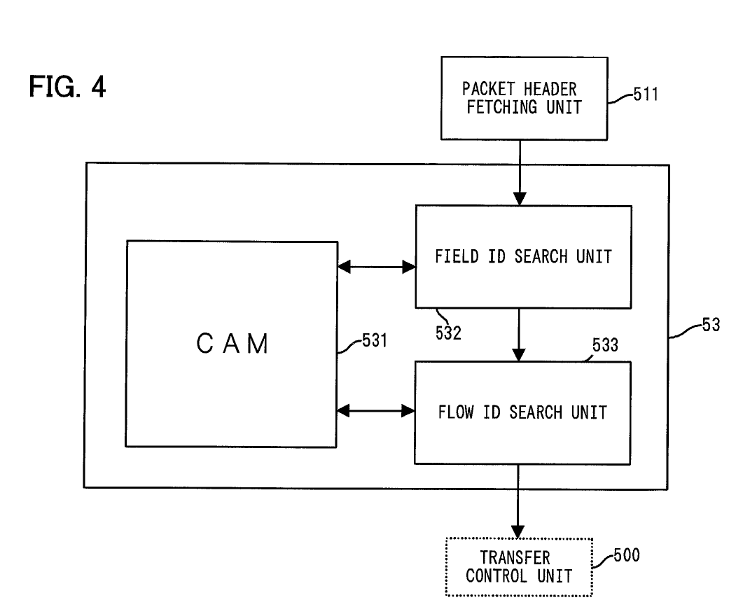

Here, an example of configuring the flow search circuit 53 will be described. FIG. 4 is a configuration drawing showing an example of configuring the flow search circuit 53.

The flow search circuit 53 comprises a CAM 531, that registers the data to be used for the flow search circuit 53 in advance, and decides if the data is proper for a search condition, a field ID search UNIT 532, that receives the header data outputted from a packet fetching UNIT 511 in the parameter extraction circuit 51, controlling the CAM 531, and outputs a primary search result as a field match ID, and a flow ID search UNIT 533, that controls the CAM 531 with the field match ID as a search condition, and outputs a flow ID as a secondary search result.

In this configuration example, the CAM 531 which has a variable mask function and is able to set a valid/invalid range of the individual registered data for every bit is used. Also, in an example as illustrated in FIG. 4, the CAM 531 is to be used in common by the field ID search UNIT 532 and the flow ID search UNIT 533.

In addition, in FIG. 4, a transfer control UNIT 500 denotes a summary of a function UNIT following the flow search circuit 53 illustrated in FIG. 3, in other words, the second route list 55, a judgment circuit 56 and a band control UNIT 57. In this transfer control UNIT 500, the information from the field search circuit 52 and the flow search circuit 53 is used as a pointer to the first and the second route lists 54 and 55, and routing will be determined at the judgment circuit 56, by a combination of the route information outputted from the first and the second route lists 54, to convert header.

Here, the SDH of the optical SDH termination UNIT 60 denotes a fast digital transfer network, which has a speed unit of 155.52 Mbps. The VPI/VCI to be converted at the ATM termination UNIT 61 denotes a connection identifier of the ATM technology, and is used to identify a virtual path (VP) for cell transfer, and a virtual channel (VC).

A frame of the SDH transferred from the ATMSW 40 will be sequentially transferred from the optical SDH termination UNIT 60 to the packet header fetching UNIT 511 at the parameter extraction UNIT 51 for the address solution UNIT 50. By this operation, the packet header fetching UNIT 511 will receive the IP header within the ATM cell.

In the case of a packet transferred from the core network 10, at the head of the IP header, a core header will be included. The core header will be added to a packet which passes through the core network 10. The packet header fetching UNIT 511 will confirm that the value of the added IP header being normal.

After the confirmation, based on the information of the IP header or the core heater, necessary information for routing will be obtained. At the flow search circuit 53, search will be executed, using the CAM 531, with the necessary information for routing as a search condition, so that a specific flow can be obtained.

At the transfer control UNIT 500, a sending header will be assembled from the routing information of the packet header fetching UNIT 511 and the flow search circuit 53. If a packet is judged to be sent to the core network, a core header is also added to the sending header.

By sequential transfer from the transfer control UNIT 500 to the optical SDH termination UNIT 60, a frame of the SDH will be created. The created SDH frame will be then sent to the ATMSW 40.

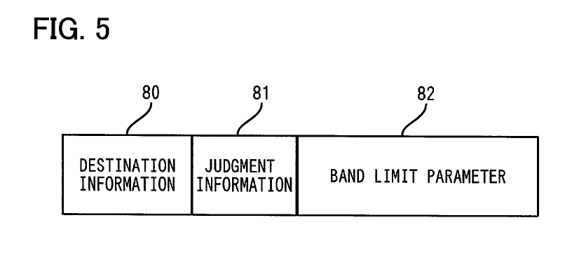

As explained by returning back to FIG. 3, the first route list 54 and the second route list 55 comprise tables of route information. By the pointers of the tree search result by the tree search circuit 52, and the flow search result by the flow search circuit 53, applicable route information can be referred to on the first route list 52 and the second route list 53, respectively. The route information is as shown in FIG. 5 as an example. The route information comprises a destination information 80, a judgment information 81 and a band limit parameter 82.

The judgment information contained in the route information of the first route list 54 and the second route list 55 will be combined by the judgment logic held by the judgment circuit 56 and solved into one route information.

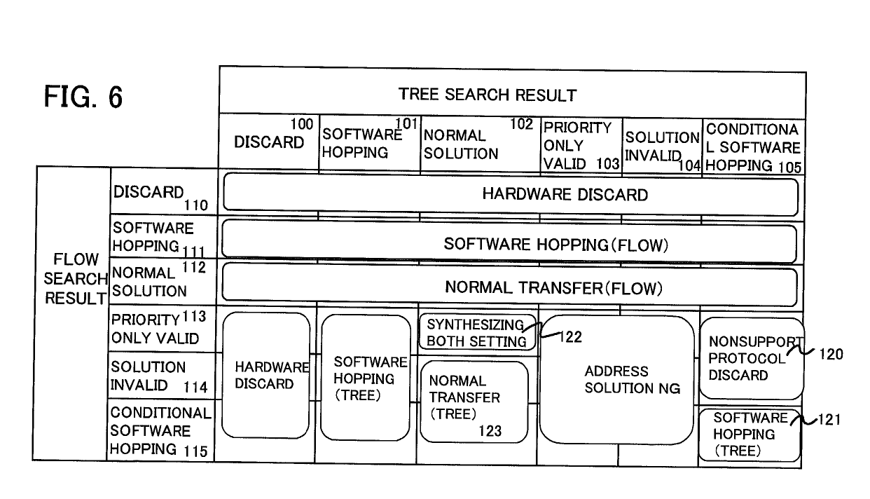

The judgment logic in the judgment circuit 56 is as shown in FIG. 6 as an example.

Here, considerations are made on band restriction parameters relating to the application of the present invention.

[Parameter for Polishing]

This parameter shows the setting rate when the packet amount of a specific flow is to be monitored by the band control UNIT 57 and a method to process illegal packets. As to packets exceeding the given flow rate, such packets will be discarded, or outputted by lowering a degree of priority shown by parameters other than the above. Under the present invention, this parameter is a central parameter of the “band control”.

[Priority within the Core Network]

The parameter which is added in the core header, and is used to control discarding at the time of convergence at each apparatus when the core network is transferred, or to control read priority from the buffer.

[Discarding Priority within the ATM Network]

The parameter to instruct an easiness of discarding at the time of convergence of the ATM network. Specifically, this parameter is applicable to the CLP (Cell Loss Priority) bit of the ATM header.

[Read Priority from the Packet Accumulator UNIT]

Parameter to control the read order when the packet data is outputted from the buffer for the packet accumulator UNIT. It affects the transfer delay of packets.

[Discard Priority at a Shaper]

Parameter to instruct an easiness of discarding when the shaper's buffer became convergent, in shaping treatment (to adjust the sending intervals of the ATM cell depending on a receiver apparatus) to be performed at the ATM termination UNIT 61.

[Read Priority at the Shaper Buffer]

Parameter to control the order of reading from the buffer, at the same buffer of the shaper as described above.

[DMA Channel at the Time of Software Hopping]

It means the DMA channel when a packet is transferred from the pack accumulator/divider UNIT 63 to the software processor UNIT 64, (or it may mean the queue number which software monitors). Software will perform analyzing treatment of packets by attaching a degree of priority to every queue in advance.

Out of the route information shown in FIG. 5, the destination information 80 has the internal channel for transferring a packet to the destination node. As the judgment information 81 is classified into five types, a normal solution, software hopping, conditional software hopping, only priority is valid and discard, whichever type can be set from these five types.

The normal solution means transfer to the destination node. The software hopping means transfer to the software processor 6 4.

The conditional software hopping means conditional transfer to the software processor UNIT 64, as a result of both two searches. The only priority is valid means that only the band limit parameter 82 is regarded valid, and the destination information 80 regards the result of other search valid. The discard means discarding is executed by hardware at the packet accumulator/divider UNIT 63.

The band limit parameter 82 is a parameter used at the band control UNIT 57, the packet accumulator/divider UNIT 63 and at the ATM termination UNIT 61.

In the judgment logic as shown in FIG. 6, processing is determined by the combination of the following six types of parameters, discard (100, 110), software hopping (101, 111), normal solution (102, 112), only priority valid (103, 113), solution invalid (104, 114), and conditional software, hopping 105, 115), which are the search results by the tree search circuit 52 and by the flow search circuit 53.

The parameters other than the solution invalid (104, 114) are applicable to the judgment information 81 of the route information. The solution invalid (104, 114) is applied when the route information cannot be obtained, in other words, when there is no applicable setting in tree search/flow search.

In FIG. 6, the area where the parameters denoting the search result of the tree search and the search result of the flow search are crossing, means the result of judgment made by the judgment circuit 56. The space inside the parentheses contained in the judgment result is for a judgment which route information to be valid.

The following shows some explanations on a representative solution, setting for solution and resultant motions.

(a) Software Hopping By the Search Result at the Tree Search Circuit 52

At the packet to be received, the tree search circuit 52 will be set so that a pointer of the route information can be obtained from the destination address, and the first route list 54 will set software hopping for the judgment information 81 for an applicable route information.

Moreover, the flow search circuit 53 will be set so that a pointer of the route information cannot be obtained from the parameter extracted at the parameter extracted at the parameter extraction UNIT 51.

When the packet is received, to the judgment circuit 56, the result of the tree search being soft hopping (101), and the result of the flow search being solution invalid (114) will be inputted, and soft hopping caused by the tree search result will be determined by the judgment logic shown in FIG. 6.

(b) Software Hopping Caused By the Tree Search Result Using the Conditional Software Hopping

At the packet to be received, the tree search circuit 52 will be set so that a pointer of the route information can be obtained from the destination address, and the first route list 54 will set a conditional software hopping for the judgment information of an applicable route information.

Also, the flow search circuit 53 will be set so that a pointer of the route information can be obtained when a protocol type matches, and the second route list 55 will set a conditional software hopping for the judgment information of an applicable route information.

When the packet matching the protocol type is received, to the judgment circuit 56, input is made that both of the tree search result and the flow search result being conditional software hopping (105, 115), thereby resulting in software hopping (121) caused by the tree search result, by the judgment logic shown in the same drawing.

Or, when the packet that does not match the protocol type is received, to the judgment circuit 56, input is made that the tree search result being conditional software hopping (105), and the flow search result being solution invalid (114), thereby resulting in non-support protocol discard (120) by the judgment logic shown in FIG. 6.

By the above described (a), the packet sent to the set destination address will be subject to software hopping. However, even the packet whose protocol type was not normal at the set destination IP address, will be also subject to software hopping. Such software hopping can be avoided by a logic that only packets matching the protocol type will be subject to software hopping, as described in the above (b).

(c) Synthesizing Both Settings

At the packet to be received, the tree search circuit 52 will be set so that a pointer of the route information can be obtained from the destination address, and the first route list 54 will set a normal solution for the judgment information of an applicable route information.

Moreover, the flow search circuit 53 will be set so that a pointer of the route information can be obtained when a certain source address matches, or when a certain protocol type matches, and the second route list 55 will set a priority only valid for the judgment information of an applicable route information.

When the received packet has the matching source address or matching protocol type, to the judgment circuit 56, input will be made that the tree search result being normal solution (102), and the flow search result being priority only valid (113), because of its conformity, thereby resulting in synthesize (122) of both settings, by the judgment logic shown in the same drawing.

To synthesize both settings (122), a method is taken to determine the route information, that the destination information 80 can be seen from the route information of the tree search result side, and the band limit parameter 82 can be seen from the route information of the flow search result side.

Also, when the received packet has non-conforming source address or protocol type, to the judgment circuit 56, input will be made that the tree search result being normal solution (102), and the flow search result being solution invalid (114) because of its non-conformity, thereby resulting in normal transfer (123) by means of tree, by the judgment logic shown in the same drawing.

By the above described (c), the band control parameter 80 can be obtained for any flow of a certain source address, or a certain protocol type, regardless of a destination address. In other words, regardless of destination nodes, flexible band control can be made.

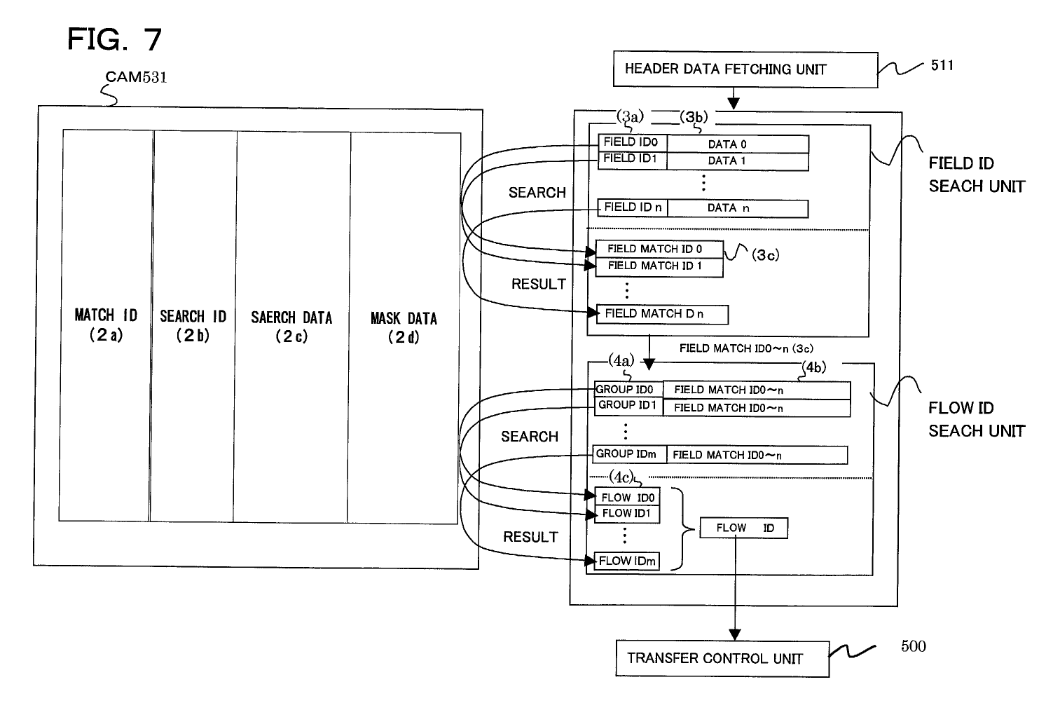

Here, an embodiment example of the flow search circuit 53 will be explained. FIG. 7 shows a functional configuration and a flow of motions of a field ID search UNIT 532 to search a specific flow from the IP header, and a flow search UNIT 533.

[A] A packet fetching UNIT 511 in a parameter extraction UNIT 51 for an address solution UNIT 50 will check the IP header and obtain the necessary information for routing.

The flow search circuit 53 will search a specific flow, using the CAM 531 from the IP header sent from the packet fetching UNIT 511. For this purpose, the header data will be outputted to the field ID search UNIT 532.

[B] The field ID search UNIT 532 will search with the field IDs 0-n (3a) and data 0-n (3b) as search conditions for the CAM 531, and will output the searched field match IDs 0-n (3c) to a field ID search UNIT 533.

The data 0-n (3b) include the source address, destination address, protocol or other necessary information contained in the header data that have been divided into n pieces, and condensed data added.

Here, “condensed” means to reduce the number of bits of a certain data having a large number of bits, by coding. The condensed data in this embodiment means the data obtained by condensing a data having a large number of bits required as search conditions in the header data by another function.

The field Ids 0-n (3a) will be attached to the data 0-n (3b), respectively. The configuration comprises 1 bit representing the field ID search, and 3 bits of data numbers 0 through n, in total 4 bits.

The field ID search UNIT 532 will input the search condition for the n pieces into the CAM 531, and receive a match ID (2a) denoting matching the search from the CAM 531, then, store the match IDS sequentially as the field match IDS (3c).

Also, if the search conditions fail to match, insert a special No. indicating mismatch to the field match ID (3c). Match means the value same as the search condition is already set within the table of the CAM 531.

By these processing, the field match IDs 0 through n (3c) will be outputted to the flow ID search UNIT 533, as a primary search result.

[C] The CAM 531 has a table comprising a match ID (2a), search ID (2b), search data (2c) and mask data (2d). The data (3b) of the search condition outputted from the field ID search UNIT 532 conforms to the search data (2c), and the field ID (3a) conforms to the search ID (2b).

Similarly, the field match IDs 0 through n (3c) of the search condition outputted from the flow ID search UNIT 532 conform to the search data (2c), and group IDs 0 through m (4a) conform to the search ID (2b). The group ID (4a) will be explained later.

The mask data (2d) denotes the valid/invalid range of the search ID (2b) and search data (2c).

In other words, as to the data within the not-masked range, if the search condition and the table agreed, it will be judged as matched. If matched, the match ID (2a) will be returned to the field ID search UNIT 532, that outputted the search condition, or to the flow ID search UNIT 533.

[D] The flow ID search UNIT 533 will use the data (4b) to store the field match IDS 0 through n (3c) outputted from the field ID search UNIT 532, and the group IDs 0 through m (4a), as search conditions.

Each of the group IDs 0 through m (4a) will be attached to the data (4b). The configuration comprises 1 bit indicating the flow ID search, and 3 bits indicating a degree of priority from 0 through m for the flow IDs (4c), in total 4 bits. A younger number will be given a higher priority.

As the individual field match IDS (3c) contained in the data are values, each of which has meanings, the purpose of the flow ID search is not limited to search whether all of the field match IDs 0 through n (3c) match or not. The true purpose of the flow ID search is to search the flow ID (4d), performing search for every specializing elements or a combination of a plurality of elements.

In order to perform the search as described above, in the present embodiment, setting is made so that the mask data (2d) of the CAM 531 can mask all except the field match ID (3c) required for individual search.

Moreover, in the case of using a CAM which cannot be set that against one search condition, there are a plurality of matching conditions in the table, or in case of using a CAM which even accepts a plurality of matching data, but does not guarantee which matches to which data, setting is made by providing values representing the individual degrees of priority from 0 through m, to avoid a plurality of matching, with the same field match IDs 0 through n (3c) as search conditions.

As operating procedure, the CAM 531 will return the match ID (2a), if matching the search, judged from the search condition sent from the flow ID search UNIT 533 and the table. The flow ID search UNIT 533 will sequentially store the match IDs 0 through m (2a) received from the CAM 531, as flow IDs 0 through m (4c).

From the obtained flow IDs 0 through m (4c), a flow ID (4d) will be obtained depending on a degree of priority.

Such a flow ID (4d) will be a pointer to the second route list 55 as described previously.

Next, a concrete example of flow search processing will be explained.

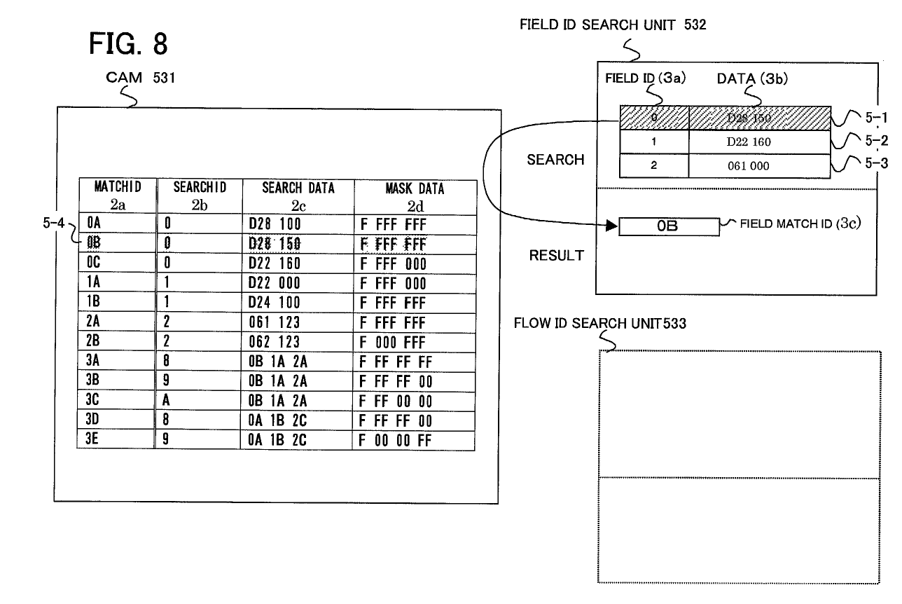

FIG. 8 shows an example of the data of the field ID search UNIT 532, method to obtain a field match ID (3c) and an example of the table for the CAM 531.

Values to be used in embodiments and those to be used in the following drawings of embodiments are the same, and all data examples are shown in the HEX form.

The data (3b) D28150, D22160 and 061000 in the field ID search UNIT 532 are examples of values disassembled the necessary section of the fetched header data. To each of the data (3b), as shown in FIG. 6, the field ID (3a) 0, 1 and 2 will be attached.

An example of set data is shown in the table of the CAM 531. When the bit of the mask data is ‘0’, this ‘0’ denotes the masked state, and the bit is invalid.

When the bit of the mask data is ‘1’, this ‘1’ denotes the not-masked state, and the bit is valid. Four bits from the upper of the mask data correspond to the search ID (2b), and twenty four bits from the lower correspond to the search data (2c).

In other words, against the search condition, if in the range where the bit of the mask data being ‘1’, the search ID (2b) and the search data (2c) matched, the match ID (2a) will be outputted to the field ID search UNIT 532, as a result.

A search condition (5-1) 0 D28 150 matches a registered data (5-4) 0B 0 D28 150 FFFF FFF of the CAM 531. By this matching, a match ID (2a) 0B will be outputted to the field ID search UNIT 532, as a result.

The field ID search UNIT 532 will hold a field match ID 0 (3c) as 0B.

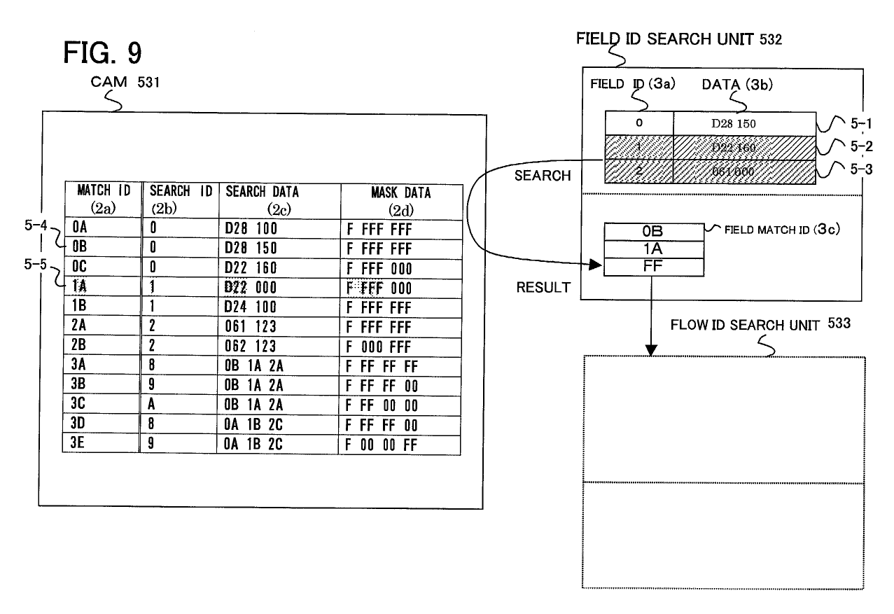

FIG. 9 shows a method to output field match ID1 and ID2 (3c). A search condition (5-2) 1 D22 160 matches a registered data (5-5) 1A 1 D22 000F FFF 000 of the CAM 531. By this matching, a match ID (2a) 1A will be outputted to the field ID search UNIT 532, and the field ID search UNIT 532 will hold the output as a field match ID 1 (3c) 1A.

To the following search condition (5-3) 2 061 000, there is no matching value in the table of the CAM 531. By this absence, the field ID search UNIT 532 will hold a special number FF denoting the not-matched result, as a field match ID 2 (3c) FF.

The field ID search UNIT 532 will output these field match ID0 through ID2 (3c) 0B, 1A and FF to the flow ID search UNIT 533.

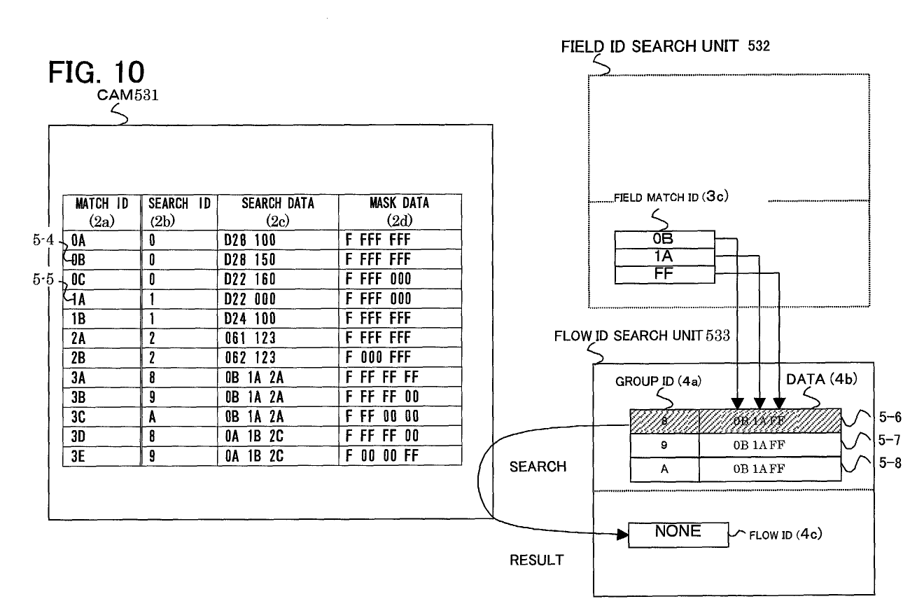

FIG. 10 shows a method to generate a search condition of the flow ID search UNIT 533, and a method to obtain a flow ID0 (4c).

The data (4b) of the flow ID search UNIT 533 in the same drawing will store the field match IDs 0 through 2 (3c) 0B, 1A and FF, as the data. As shown in FIG. 10, group IDS (4a) 8, 9 and A will be attached to the data.

As a search condition ID 8 (5-6), 0B 1A FF does not have any matching value in the table of the CAM 531, processing will go on to the next flow ID search.

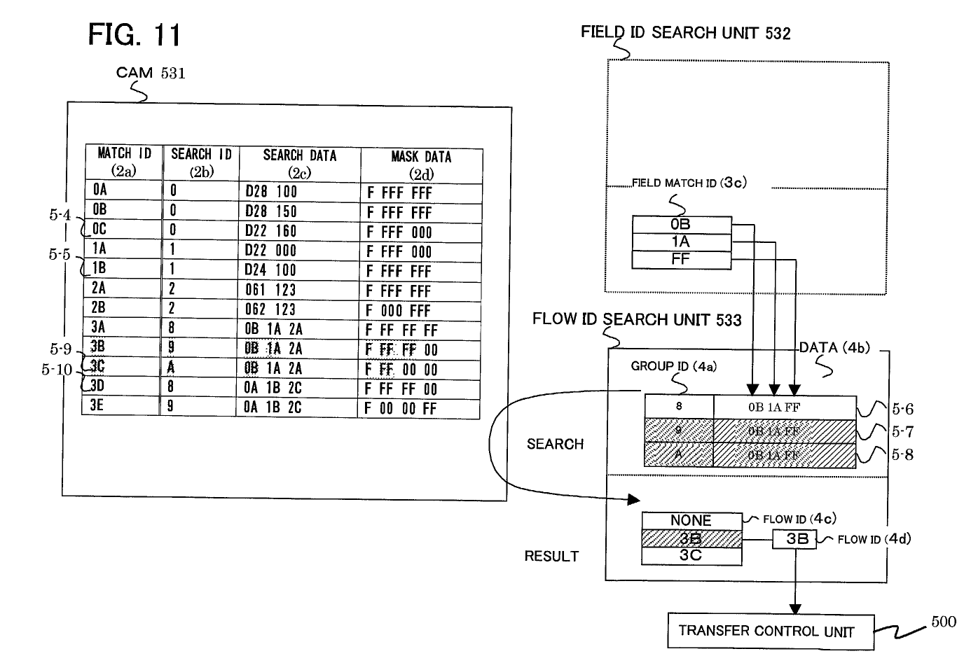

FIG. 11 shows a method to obtain flow IDS 1 and 2 (4c) of the flow ID search UNIT 533, and a method to output a final flow ID (4d). A search condition 9 (5-7), 0B 1A FF matches a registered data ID 3B (5-9), 9 0B 1A 2A F FF FF 00 of the CAM 531. By this matching, the match ID 3B (2a) will be outputted to the flow ID search UNIT 533, and the flow ID search UNIT 533 will hold the output as a flow ID 3B (4c).

Next search condition (5-8) A 0B 1A FF matches a registered data ID 3C (5-10) A 0B 1A 2A FFF00 00 of the CAM 531. By this matching, a match ID 3C (2a) will be returned to the flow ID search UNIT 533, and the flow ID search UNIT 533 will hold the returned ID as a flow ID 3C (4c).

From the obtained flow ID3B and ID 3C (4c), in accordance with a degree of priority, ID3B will be outputted as a final flow ID (4d).

The final flow ID (4d) will be inputted to the transfer control UNIT 500.

As set forth hereinabove, the flow search executed at the flow search circuit 53 is a processing to search only a “specified flow” with hardware, using the CAM 531, with a condition combining a plurality of parameters to be mounted on the IP header.

The specified flow means the data to exchange information in the protocol to manage the route information and network from the IP header. Hardware processing comprises processing to search individual contents of each parameter for which mask can be set, and processing to search combined conditions of each parameter for which mask can be set, by repeating processing a plurality of times.

As the above shows the descriptions about the embodiments along with the related drawings, the present invention enables an embodiment of search of a high-capacity and a plurality of parameters required for hardware routing, by combining the tree search using the RAM that is able to make a high-capacity setting, and the flow search using the CAM that is able to search by a plurality of parameters.

By preventing software from processing useless packets, discarding of packets that essentially need processing can be avoided, thereby contributing to the improvement in the apparatus reliability. Also, at the same time, because loading of software can be reduced, the further improved performance of total software processing, including abnormal processing can be expected.

Compared with the conventional method, a more economical and more compact priority control can be embodied, instead of a complicated priority control.

What is claimed is:

1. A packet transfer control method in which a transfer destination can be solved from header information of an IP packet, the method comprising the steps of:
finding, by means of hardware processing, a first route information which has been address solved by a tree search using a destination address contained in the header information of the IP packet;
finding a second route information which has been solved by information, excluding the destination address, that specifies a packet; and
combining the first and the second route information to judge the execution of transfer to software.

2. The packet transfer control method according to claim 1, wherein
the information, excluding the destination address, that specifies a packet includes a source address, protocol type and port number at TCP/UDP or other packet header information, or includes identifying information to be given to a packet within an apparatus.

3. The packet transfer control method according to claim 1, further comprising the steps of:
giving individual band control conditions to each of the first and the second route information; and
combining the first and the second routes to determine a final band control.

4. A packet transfer control method in which a transfer destination is solved from header information of an IP packet, the method comprising the steps of:
searching a destination by a tree search, with a destination parameter contained in the header information of the IP packet as a search condition; searching specified flow data by use of a memory that is able to search by hardware whether the specified flow data is in data set for one input data, the specified flow data exchanging route information and information in a protocol that performs network management, from a plurality of parameters contained in the header information of the IP packet; and
combining the destination searched by the tree search and the specified flow data to judge the execution of transfer to software.

5. The packet transfer control method according to claim 4, wherein the step of searching the specified flow data by use of the memory includes the steps of individually searching the contents of each parameter that can be masked, and searching by a plurality of times decoding conditions of each parameter that can be masked.

6. The packet transfer control method according to claim 4, wherein
the data set for one input data are configured to have data and a mask to determine an effective range on a data-to-data basis.

7. A packet transfer control system having an edge node connecting an access network and a core network, the edge node converting an IP packet into a core network address for each destination of the packet so that transfer through the core network can be made via an optimum route, the system comprising:
means for, by hardware processing, finding a first route information which has been address solved by a tree search depending on a destination address contained in header information;
means for finding second route information which has been solved by information, excluding a destination address, that specifies a packet; and
means for combining the first and the second route information to judge the execution of transfer to software.

8. The packet transfer control system according to claim 7, wherein
the information, excluding the destination address, that specifies a packet includes a source address, protocol type and port number at TCP/UDP or other packet header information, or includes ID information to be given to a packet within an apparatus.

9. The packet transfer control system according to claim 8, further comprising:
means for giving individual band control conditions to each of the first and the second route information, the means combining the first and the second routes to determine a final band control.

10. A packet transfer control system having an edge node connecting an access network and a core network, the edge node converting an IP packet into a core network address for each destination of the packet so that transfer through the core network can be made via an optimum route, wherein
the edge node comprises:
means for searching a destination by a tree search, with a destination parameter contained in the header information of the IP packet as a search condition;
a memory (CAM: content Addressabe Memory) for allowing a hardware search of whether to lie within data set for one input data;
means for searching, by use of the memory, a specified flow data exchanging route information and information in a protocol that performs network management, from a plurality of parameters contained in the header information of the IP packet; and
means for combining the destination searched by the tree search and the specified flow data to judge the execution of transfer to software.

11. The packet transfer control system according to claim 10, wherein the means for searching the specified flow data by use of the memory includes means for individually searching the contents of each parameter that can be masked, and means for searching by a plurality of times decoding conditions of each parameter that can be masked.

12. The packet transfer control system according to claim 10, wherein
the data set for one input data are configured to have data and a mask to determine an effective range on a data-to-data basis.
